(19) United States
(12) Patent Application Publication
(10) Pub. No.: US 2013/0145054 A1
(43) Pub. Date: Jun. 6, 2013

(54) SUPERVISING A DATA STORAGE SYSTEM

(71) Applicants: Vitaly S. Kozlovsky, St. Petersburg (RU); Mikhail A. Ilyin, St. Petersburg (RU)

(72) Inventors: Vitaly S. Kozlovsky, St. Petersburg (RU); Mikhail A. Ilyin, St. Petersburg (RU)

(73) Assignee: EMC CORPORATION, Hopkinton, MA (US)

(21) Appl. No.: 13/394,214

(22) PCT Filed: Dec. 2, 2011
(86) PCT No.: PCT/RU2011/000953

§ 371 Date: Mar. 5, 2012

(51) Int. Cl. G06F 3/14

(52) U.S. Cl. 710/19

(57) ABSTRACT

A method and system for use in supervising a data storage system is disclosed. The status of an operational feature in the data storage system is monitored. A human perceptible signal is outputted in response to monitoring the status of the operational feature in the data storage system. The data storage system outputs the human perceptible signal locally thereto indicating the current status of the operational feature in the data storage system.

### TECHNICAL FIELD

The invention relates to supervising a data storage system.

### BACKGROUND OF THE INVENTION

Computer systems may include different resources used by one or more host processors. Resources and host processors in a computer system may be interconnected by one or more communication connections. These resources may include, for example, data storage devices such as those included in the data storage systems manufactured by EMC Corporation. These data storage systems may be coupled to one or more servers or host processors and provide storage services to each host processor. Multiple data storage systems from one or more different vendors may be connected and may provide common data storage for one or more host processors in a computer system.

A host processor may perform a variety of data processing tasks and operations using the data storage system. For example, a host processor may perform basic system I/O operations in connection with data requests, such as data read and write operations.

Host processor systems may store and retrieve data using a storage device containing a plurality of host interface units, disk drives, and disk interface units. The host systems access the storage device through a plurality of channels provided therewith. Host systems provide data and access control information through the channels to the storage device and the storage device provides data to the host systems also through the channels. The host systems do not address the disk drives of the storage device directly, but rather, access what appears to the host systems as a plurality of logical disk units. The logical disk units may or may not correspond to the actual disk drives. Allowing multiple host systems to access the single storage device unit allows the host systems to share data in the device. In order to facilitate sharing of the data on the device, additional software on the data storage systems may also be used.

Computers, computer networks, and other computer-based systems are becoming increasingly important as part of the infrastructure of everyday life. Networks are used for sharing peripherals and files. In such systems, complex components are the most common sources of failure or instability. The proliferation of multiple interacting components leads to problems that are difficult or impossible to predict or prevent. The problems are compounded by the use of networks, which introduce the added complexity of multiple machines interacting in obscure and unforeseen ways.

Additionally, the need for high performance, high capacity IT systems is driven by several factors. In many industries, critical IT applications require outstanding levels of service. At the same time, the world is experiencing an information explosion as more and more users demand timely access to a huge and steadily growing mass of data including high quality multimedia content. The users also demand that information technology solutions protect data and perform under harsh conditions with minimal data loss and minimum data unavailability. Computing systems of all types are not only accommodating more data but are also becoming more and more interconnected, raising the amounts of data exchanged at a geometric rate.

To address this demand, modem data storage systems (“storage systems”) are put to a variety of commercial uses. For example, they are coupled with host systems to store data for purposes of product development, and large storage systems are used by financial institutions to store critical data in large databases. For many uses to which such storage systems are put, it is highly important that they be highly reliable so that critical data is not lost or unavailable.

It will be appreciated that different tasks may be performed in connection with data storage systems. For example, software may be executed on the data storage systems in connection with performing data storage administration tasks such as for data storage configuration, management, and/or monitoring. The monitoring of data storage systems may include analyzing the health of the data storage system and investigating the cause of a failure in the data storage system when the data storage system fails to function successfully. The monitoring of the data storage system may be performed by services such as a data collection service, a configuration service and a performance analyzer service. For example, the data collection service may gather logs of the storage system (“system logs”), snapshots of the data storage system's memory, configuration and status information of the data storage system. It will be appreciated in case of a failure in such storage systems, it is useful that the information is investigated in a timely manner for preventing further failures in such storage systems.

However, it is also useful that potential problems in connection with data storage systems are identified before a failure or crisis situation arises. If a crisis situation is left to develop it may be too late to rectify the problem in the data storage system without causing disruption and inconvenience to the users of the data storage system.

### SUMMARY OF THE INVENTION

A method and system for use in supervising a data storage system is disclosed. The status of an operational feature in the data storage system is monitored. A human perceptible signal is outputted in response to monitoring the status of the operational feature in the data storage system. The data storage system outputs the human perceptible signal locally thereto indicating the current status of the operational feature in the data storage system.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment of a system that may utilize the techniques described herein;

FIG. 2 is a diagram illustrating in more detail components of FIG. 1 that may utilize the techniques described herein;

FIG. 3 is a diagram illustrating in more detail components of FIG. 1 that may utilize the techniques described herein;

FIG. 4 is a flowchart of processing steps that may be performed in an embodiment in accordance with techniques described herein;

FIG. 5 is a flowchart of processing steps that may be performed in an embodiment in accordance with techniques described herein; and

FIG. 6 is a front view of a data storage system incorporating the techniques as described herein.

### DETAILED DESCRIPTION

The invention can be implemented in numerous ways, including as a process, an apparatus, a system, a computer program embodied on a computer readable storage medium, and/or a processor, such as a processor configured to execute instructions stored on and/or provided by a memory coupled to the processor. In this specification, the implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Described below are techniques for use in supervising a data storage system. The techniques can perform service actions and system supervision without the necessity of having to connect to a data storage system via a common user interface such as a command-line interface (hereinafter “CLI”) or a graphical user interface (hereinafter “GUI”). The techniques can allow an administrator or user to supervise the data storage system by quickly looking at the front or back panel of the storage processor or disk rack. The techniques may be used not only by IT specialists but other personnel with access to the data storage system. Advantageously, the techniques can allow for early prevention of problems or issues.

The techniques may comprise use of a panel of visual indicators, which might be either built-in, located on front or back side of the storage processor, or may be implemented as removable module using one of standard interfaces, for example, USB. The panel of visual indicators may be implemented as a small LCD, a set of LED colored lamps, semi-segment indicators, or a combination of the above. The panel of visual indicators may indicate, for example, the amount/percentage of disk space used, CPU load, network load, temperature or other important internal system-specific values, warnings, alarms. A visual representation may be augmented with an audio or sound signal or notification, for example, a simple sound alarm, or voice for a case where specific attention is needed. The meaning of the indicators may be assigned programmatically by system developer/IT/user via some additional interface or settings file. As a result, the potential problems or issues may be detected at an early stage since the indicators can attract attention more easily than conventional approaches.

For example, conventional system alarms may not be triggered to notify a user when the amount of disk space moves closer to the “red zone” or danger zone. However, the techniques as disclosed herein may attract the attention of users or service personnel. If the techniques as described herein can identify a potential problem or issue it can be easily noted by a non-expert and may be reported for analysis to proper service personnel. Accordingly, the techniques can present an ability to prevent possible future failures of the data storage system significantly conserving resources and time.

It will be known by those skilled in the art that the control and supervision of computational centers and labs is very critical but traditional approaches and machinery can sometimes be not enough. On a working data storage system, the current status may be viewed remotely or via special system control panel connected to the rack. This may require the usage of specific software for status displaying, control and automated issue triggering/reporting. The conventional systems may have no indication of the status of, for example, the disc volume allocated, current CPU load, current network load, CPU temperature, system alarms etc. The status could not be viewed by service personnel without logging-in to the system. It will be appreciated that widely used system event alarm notifications like SMS/e-mail or other triggers may not be enough for early issue diagnostics. The amount of free disk space in storage and its current productivity can remain out of sight to the experts up to the moment of a “crisis” situation.

It will be appreciated that the techniques as described herein may only require a quick glance on the indicator panel or interface to ascertain the status. For small range systems, the techniques as described herein can operate with minimum supervision of IT specialists. As a result, the potential problems or issues may be addressed and prevented at an early stage.

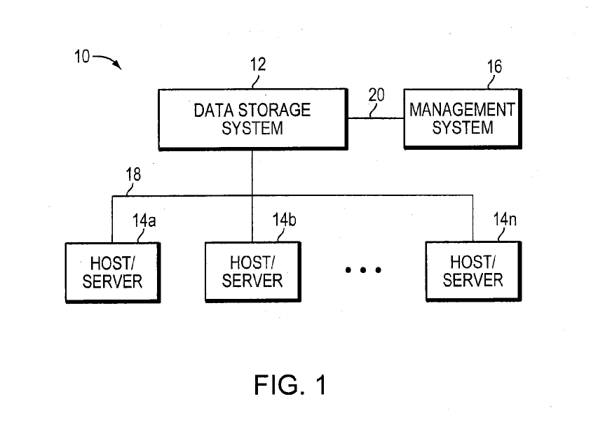

Referring to FIG. 1, there is illustrated an example of a system that may be used in connection with performing the techniques as described herein. The system 10 includes a data storage system 12 connected to servers or host systems 14a-14n through a communication medium 18. It will be appreciated by those skilled in the art that the data storage system 12 may include one or more data storage systems such as one or more of the data storage systems offered by EMC Corporation of Hopkinton, Mass. The system 10 also includes a management system 16 connected to one or more data storage system 12 through a communication medium 20. In this embodiment, the management system 16, and the N servers or hosts 14a-14n may access the data storage system 12, for example, in performing input/output (I/O) operations, data requests, and other operations. The communication medium 18 and the communication medium 20 may be any one or more of a variety of networks or other type of communication connections as known to those skilled in the art. For example, the communication medium 18 and 20 may be a network connection, bus, and/or other type of data link, such as a hardwire or other connections known in the art.

Each of the host systems 14a-14n and the data storage system 12 included in the system 10 may be connected to the communication medium 18 by any one of a variety of connections as may be provided and supported in accordance with the type of communication medium 18. Similarly, the management system 16 may be connected to the communication medium 20 by any one of variety of connections in accordance with the type of communication medium 20. The processors included in the host computer systems 14a-14n and management system 16 may be any one of a variety of proprietary or commercially available single or multi-processor system, such as an Intel-based processor, or other type of commercially available processor able to support traffic in accordance with each particular embodiment and application.

It should be noted that the particular examples of the hardware and software that may be included in the data storage system 12 are described herein in more detail, and may vary with each particular embodiment. Each of the host computers 14a-14n, the management system 16 and data storage system may all be located at the same physical site, or, alternatively, may also be located in different physical locations. In connection with communication mediums 18 and 20, a variety of different communication protocols may be used such as SCSI, Fibre Channel, iSCSI, and the like. Some or all of the connections by which the hosts, management system, and data storage system may be connected to their respective communication medium may pass through other communication devices, such as a Connectrix or other switching equipment that may exist such as a phone line, a repeater, a multiplexer or even a satellite. In one embodiment, the hosts may communicate with the data storage system over an iSCSI or a Fibre Channel connection and the management system may communicate with the data storage systems over a separate network connection using TCP/IP. It should be noted that although FIG. 1 illustrates communications between the hosts and data storage system being over a first connection, and communications between the management system and the data storage systems being over a second different connection, an embodiment may also use the same connection. The particular type and number of connections may vary in accordance with particulars of each embodiment.

Each of the host systems may perform different types of data operations in accordance with different types of tasks. In the embodiment of FIG. 1, any one of the host computers 14a-14n may issue a data request to the data storage system 12 to perform a data operation.

The management system 16 may be used in connection with management of the data storage system 12. The management system 16 may include hardware and/or software components. The management system 16 may include one or more computer processors connected to one or more I/O devices such as, for example, a display or other output device, and an input device such as, for example, a keyboard, mouse, and the like. A data storage system manager may, for example, view information about a current storage volume configuration on a display device of the management system 16, provision data storage system resources, and the like.

In one embodiment, the data storage system 12 of FIG. 1 may be an appliance with hardware and software for hosting the data storage of the one or more applications executing on the hosts 14a-14n. The appliance may include components such as one or more storage processors and one or more data storage devices upon which data is stored. The appliance may include software used in connection with storing the data of the hosts on the appliance and also software used in connection with retrieving data from the data storage system in connection with techniques described herein.

In connection with an embodiment in which the data storage system 12 is an appliance including hardware and software, the appliance may also include other software for performing different data services. For example, the appliance may include a data collection service which interacts with software on the hosts 14a-14n when performing a data collection operation on the data storage system 12.

In another embodiment, the data storage system 12 may include one or more data storage systems such as one or more of the data storage systems offered by EMC Corporation of Hopkinton, Mass. Each of the data storage systems may include one or more data storage devices, such as disks. One or more data storage systems may be manufactured by one or more different vendors. Each of the data storage systems included in 12 may be inter-connected (not shown). Additionally, the data storage systems may also be connected to the host systems through any one or more communication connections that may vary with each particular embodiment and device in accordance with the different protocols used in a particular embodiment. The type of communication connection used may vary with certain system parameters and requirements, such as those related to bandwidth and throughput required in accordance with a rate of I/O requests as may be issued by the host computer systems, for example, to the data storage systems 12. It should be noted that each of the data storage systems may operate stand-alone, or may also be included as part of a storage area network (SAN) that includes, for example, other components such as other data storage systems.

In such an embodiment in which the data storage system 12 of FIG. 1 is implemented using one or more data storage systems, each of the data storage systems may include code thereon for performing the techniques as described herein for supervising the data storage system.

Servers or host systems, such as 14a-14n, provide data and access control information through channels to the one or more storage systems, and the storage systems may also provide data to the host systems also through the channels. The host systems may not address the disk drives of the storage systems directly, but rather access to data may be provided to one or more host systems from what the host systems view as a plurality of logical devices or logical volumes (LVs). The LVs may or may not correspond to the actual disk drives. For example, one or more LVs may reside on a single physical disk drive. Data in a single storage system may be accessed by multiple hosts allowing the hosts to share the data residing therein. An LV or LUN (logical unit number) may be used to refer to the foregoing logically defined devices or volumes.

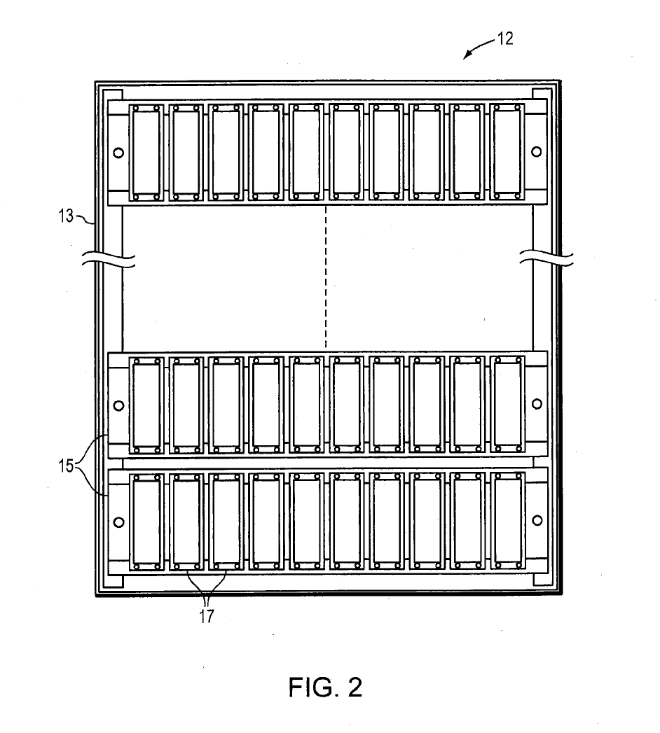

Referring to FIG. 2, there is illustrated an example of a data storage system 12 in a system 10 that may be used in connection with performing the techniques as described herein. The data storage system comprises a rack mount cabinet 13 including several storage enclosures 15. Each storage enclosure 15 includes several data storage devices, for example, disk drives 17. The disk drives and the enclosures are preferably interconnected via a serial bus loop or ring architecture, e.g., Fibre Channel Arbitrated Loop (FC-AL).

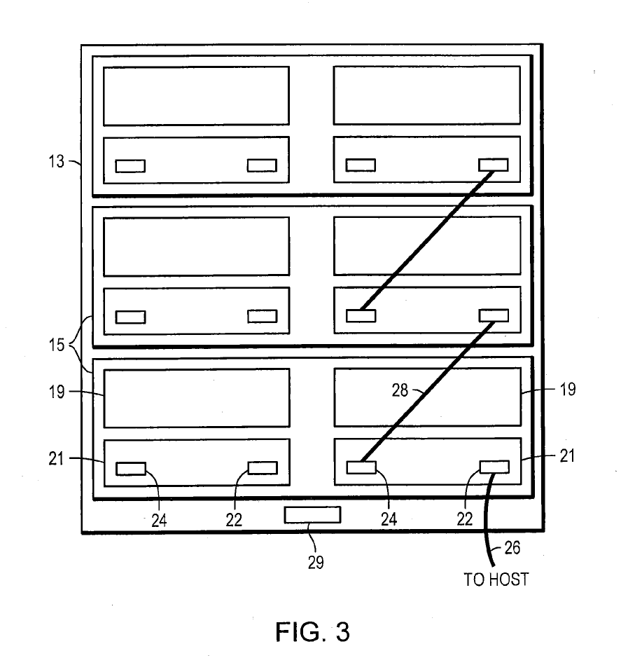

Referring to FIG. 3, there is illustrated a rear view of the rack mount cabinet 13 and the storage enclosure 15. Each storage enclosure includes two power supplies 19, and two LCCs 21. The power supplies 19 and link control cards (LCC) 21 are coupled to the disk drives 17 via a midplane within the chassis (not shown in FIG. 2). The link control card 21 serves to interconnect the disks and enclosures on the communication loop FC-AL.

Each link control card 21 includes a primary port 22 and an expansion port 24. These ports are used to link the storage enclosures together on a single communication loop FC-AL. A cable 26 may come from a host or from another storage system, and plugs into the primary port 22. The communication loop FC-AL extends from the primary port 22, is coupled to the disk drives 17, and continues out the expansion port 24. A cable 28 couples the expansion port 24 of a first storage enclosure 15 to the primary port 22 of a second storage enclosure 15. All the storage enclosures 15 are interconnected in this manner in a daisy chain to form the communication loop FC-AL. Thus, all the disk drives 17 are interconnected on the same communication loop FC-AL. Each link control card 21 is capable of controlling all the disks 17 in a given enclosure. The data storage system 12 may also include a peripheral device connector 29 that allows stand-alone peripheral devices to be connected thereto.

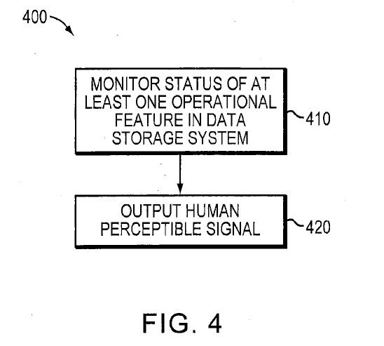

Referring to FIG. 4, there is illustrated a flowchart of processing steps that may be performed in an embodiment in accordance with a technique as described herein. The technique as illustrated generally by the reference numeral 400 is configured for use in supervising a data storage system. It will be appreciated by those skilled in the art the data storage system may be similar to the data storage system 12 as described above. For example, the components in the data storage system may comprise at least one data storage device and at least one storage processor. The technique comprises monitoring 410 at least one operational feature in the data storage system. For example, the operational feature may be data storage usage or allocation in connection with a data storage device. The technique may monitor other operational features in the data storage system such as CPU load or CPU temperature. The technique also comprises outputting 420 a human perceptible signal in response to monitoring the at least one operational feature in the data storage system. The data storage system outputs the human perceptible signal locally thereto indicating the current status of the operational feature therein. The signal is readily discernible by a human. For example, the human perceptible signal may be a visual signal outputted on an interface such as a LCD display. The signal may indicate the amount of data storage usage or allocation in connection with a data storage device or CPU load or CPU temperature or other operational features in the data storage system. The signal outputted on the interface may indicate the current status of the operational feature in the data storage system in numerical form and/or graphical form. The technique also has the advantage that the human perceptible signal readily discernible by a human is outputted local to the data storage system such that an expert or non-expert in the vicinity of the data storage system can ascertain immediately without difficulty a potential problem in connection with the data storage system. For example, the data storage system may comprise a rack mount cabinet. The human perceptible signal may be outputted on an interface on the front, back or side panels of the rack. The technique as described herein enables a person skilled or otherwise to identify a potential problem without difficulty. The technique offers a simple and easy way of identifying a potential problem without the need of having to connect to the storage system via a CLI or GUI in order to ascertain the potential problem. The above technique is less time-consuming and easier than conventional approaches.

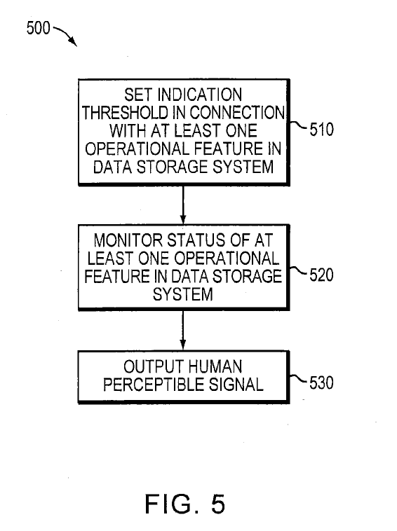

Referring to FIG. 5, there is illustrated a flowchart of processing steps that may be performed in an embodiment in accordance with a technique as described herein. The technique is illustrated generally by the reference numeral 500 and is substantially similar to the technique 400 as described above. It will be appreciated that similar steps may be implemented in a similar manner. The technique 500 is also configured for use in supervising a data storage system. It will be appreciated that the data storage system may be similar to the data storage system as described in previous figures. For example, the components in the data storage system may comprise at least one data storage device and at least one storage processor. The technique comprises setting 510 an indication threshold in connection with at least one operational feature in the data storage system. The indication threshold is a cutoff point requiring the output of the human perceptible signal. For example, the operational feature may be the data storage usage or allocation in connection with a data storage device. In such a scenario, the threshold requiring the output of the signal may be set as a defined amount of the total capacity of the data storage device. In such an example, the signal may be outputted when the total capacity of the data storage device currently allocated or in use exceeds the defined amount of the total capacity of the data storage device (i.e., the threshold). In another embodiment, the threshold may be set at a level at which it is felt that a value in excess of such a level may cause a problem. In another embodiment, the threshold is set such that the human perceptible signal can be outputted and act as an alert to a human of a forthcoming potential problem in connection with an operational feature in the data storage system. For example, if the amount of disk space usage is close to maximum the general conventional alarms may not be triggered to notify the user but the technique herein may notify the user or administrator by outputting the human perceptible signal subject to the amount of current usage exceeding the threshold. Accordingly, the technique has the ability to prevent possible future failures of the system significantly conserving resources and time. The technique also comprises monitoring 520 at least one operational feature in connection with the data storage system. The operational features may be data usage or allocation, CPU load, CPU temperature or any other operational feature in connection with the data storage system. The technique comprises outputting 530 the human perceptible signal in response to monitoring the current status of the operational feature in the data storage system reaching the indication threshold. The data storage system outputs the signal locally thereto indicating the status of the operational feature therein. The signal may be a visual signal outputted in response to data usage or allocation exceeding a set threshold. The signal may be outputted when the CPU load or CPU temperature has exceeded the set level. As discussed above, the signal may act as a forewarning of a potential problem in the data storage system

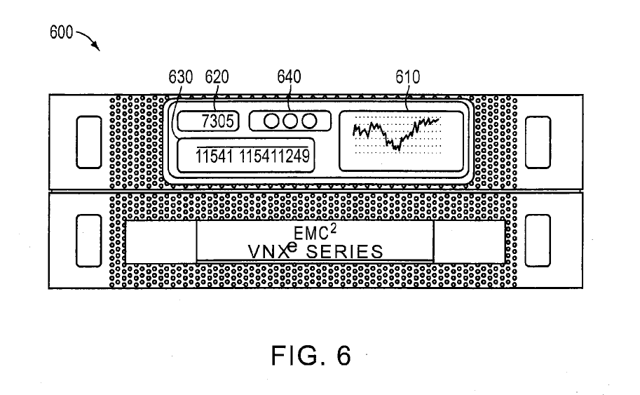

Referring to FIG. 6, there is illustrated a front view of a data storage system 600 incorporating the techniques as described herein. The data storage system 600 illustrated is a VNXe series data storage system manufactured by EMC Corp of Hopkinton, Mass. However, it will be appreciated that the technique described herein is not limited to a VNXe data storage system or an EMC manufactured data storage system. The technique described herein applies to all data storage systems. The data storage system 600 is configured for outputting a human perceptible signal indicating the current status of at least one operational feature in the data storage system. In this embodiment, the human perceptible signal is a visual signal outputted on interfaces (610, 620, 630). It will be appreciated from the figure that the interfaces (610, 620, 630) are in-built or embedded in the data storage system 600 so that the data storage system outputs the visual signal for enabling a person skilled or otherwise to readily identify the current status of the operational feature in the data storage system. It will also be appreciated from the figure that the interfaces output the visual signal in both numerical and graphical form. The data storage system also comprises a speaker 640 for outputting a human perceptible signal such as an audio signal. While the above techniques have been described with respect to outputting a human perceptible signal such as a visual signal, the signal may also, as just described, be an audio signal outputted on a speaker. Indeed, the visual signal and the audio signal may be outputted together. For example, the visual signal may be augmented by an audio signal. In the latter scenario, it may be that as the severity of the potential problem associated with the operational feature in the data storage system increases, the visual signal may be augmented by the audio signal in order to further alert a person to the potential problem in the data storage system.

While the above techniques have been described with respect to outputting a human perceptible signal such as a visual signal on an interface the signal may be outputted on an LED. The techniques may also be configured to output the signal on a LED with different colors depending on the importance or severity of the potential problem associated with the operational feature in the data storage system. For example, if the problem is particularly serious the signal may be outputted using a different color. As an example, if the data usage or allocation in connection with a data storage device was approaching maximum usage or allocation then the color may be, for example, red identifying a serious problem.

While the visual signals have been described as been outputted in numerical and/or graphical form, it will be appreciated that it may be outputted in many other forms. For example, the visual signals may be outputted as bars in the same manner as a thermometer.

While the techniques have been described in some examples as outputting the human perceptible signal indicating the amount of storage usage or storage allocation in connection with a data storage device, it will be appreciated by those skilled in the art that the techniques may output the amount of data storage usage or allocation in connection with all the data storage devices in the data storage system. The above techniques describe examples only.

While it has been described above with respect to FIG. 6 that the data storage system may output the human perceptible signal on an embedded interface and speakers, it will be appreciated that the human perceptible signal may be outputted locally on a plugged in device. For example, the device may be plugged-in to the peripheral device connector 29 that allows stand-alone peripheral devices to be connected to the data storage system.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method for use in supervising a data storage system, the method comprising:
monitoring the status of an operational feature in the data storage system; and
outputting a human perceptible signal in response to monitoring the status of the operational feature in the data storage system, wherein the data storage system outputs the human perceptible signal locally thereto indicating the current status of the operational feature in the data storage system.

2. The method as claimed in claim 1, further comprising:
setting an indication threshold in connection with the operational feature in the data storage system, wherein the indication threshold is a cutoff point requiring the output of the human perceptible signal; and
outputting the human perceptible signal in response to monitoring the current status of the operational feature in the data storage system reaching the indication threshold.

3. The method as claimed in claim 2, wherein the indication threshold is set such that the human perceptible signal can act as an alert to a human of a forthcoming problem in connection with the operational feature in the data storage system.

4. The method as claimed in claim 1, wherein the human perceptible signal is a visual signal.

5. The method as claimed in claim 4, wherein the human perceptible signal is a visual signal outputted on an interface.

6. The method as claimed in claim 5, wherein the interface is a LCD display.

7. The method as claimed in claim 4, wherein the human perceptible signal is a visual signal outputted on an LED.

8. The method as claimed in claim 1, wherein the human perceptible signal is an audio signal.

9. The method as claimed in claim 1, wherein the operational feature in the data storage system is selected from the group consisting of:
data storage usage or allocation in a data storage device
CPU load
CPU temperature
network load

10. The method as claimed in claim 1, wherein the data storage system comprises a rack mount cabinet and outputs the human perceptible signal thereon.

11. A system for use in supervising a data storage system, the system comprising:
first logic monitoring the status of an operational feature in the data storage system; and
second logic outputting a human perceptible signal in response to monitoring the status of the operational feature in the data storage system, wherein the data storage system outputs the human perceptible signal locally thereto indicating the current status of the operational feature in the data storage system.

12. The system as claimed in claim 11, further comprising:
third logic setting an indication threshold in connection with the operational feature in the data storage system, wherein the indication threshold is a cutoff point requiring the output of the human perceptible signal; and
fourth logic outputting the human perceptible signal in response to monitoring the current status of the operational feature in the data storage system reaching the indication threshold.

13. The system as claimed in claim 12, wherein the indication threshold is set such that the human perceptible signal can act as an alert to a human of a forthcoming problem in connection with the operational feature in the data storage system.

14. The system as claimed in claim 11, wherein the human perceptible signal is a visual signal.

15. The system as claimed in claim 14, wherein the human perceptible signal is a visual signal outputted on an interface.

16. The system as claimed in claim 15, wherein the interface is a LCD display.

17. The system as claimed in claim 14, wherein the human perceptible signal is a visual signal outputted on an LED.

18. The system as claimed in claim 11, wherein the human perceptible signal is an audio signal.

19. The system as claimed in claim 11, wherein the operational feature in the data storage system is selected from the group consisting of:
data storage usage or allocation in a data storage device
CPU load
CPU temperature
network load

20. The system as claimed in claim 11, wherein the data storage system comprises a rack mount cabinet and outputs the human perceptible signal thereon.
